(19) United States
(12) Patent Application Publication
(10) Pub. No.: US 2024/0173645 A1
(43) Pub. Date: May 30, 2024

(54) METHOD OF PURIFYING PARTICLE

(71) Applicant: SHENZHEN CHINA STAR OPTOELECTRONICS SEMICONDUCTOR DISPLAY TECHNOLOGY CO., LTD., Shenzhen (CN)

(72) Inventor: Miao ZHOU, Shenzhen (CN)

(21) Appl. No.: 18/084,803

(22) Filed: Dec. 20, 2022

(30) Foreign Application Priority Data
Nov. 28, 2022 (CN) 202211498989.4

(51) Int. Cl. B01D 11/04; C09C 1/30; C09C 3/00; C09C 3/12

(52) U.S. Cl. CPC B01D 11/0492; C09C 1/3009; C09C 1/3081; C09C 1/309; C09C 3/003; C09C 3/12; C01P 2002/82; C01P 2006/80

(57) ABSTRACT

A method of purifying a particle is disclosed and includes a plurality of following steps: preparing a purification solution; fully mixing a mixed solution to be purified with the purification solution, and letting stand until a plurality of separated layers appear, removing a layer of liquid where a second purification solution is located, and extracting a layer of liquid where a first purification solution is located; and freezing and drying the extracted layer of liquid to obtain a purified particle.

### CROSS REFERENCE TO RELATED APPLICATIONS

This application claims the benefit of priority of Chinese Application No. 202211498989.4 filed on Nov. 28, 2022. The contents of the above applications are all incorporated by reference as if fully set forth herein in their entirety.

### FIELD

The present disclosure relates to a field of display, and more particularly, to a method of purifying a particle.

### BACKGROUND

As display technologies become mature gradually, competition between technical specifications of organic light-emitting diodes (OLEDs), liquid crystal displays (LCDs), and micro light-emitting diodes (MLED) becomes increasingly fierce. Requirements for relevant material are raised year by year. Therefore, materials having new functions of reflectivity, haze, and transmittance are developed.

In recent years, requirements for power efficiency of display technologies are increased because of a global energy crisis and a low-carbon emission concept. Improvements in power efficiency of display devices can be achieved by enhancing efficiency of light sources, reducing light consumption between layers, increasing light emitted between layers, and controlling emitting directions of light at large viewing angles. These require material of layers to have controllable reflectivity, a capability to be patterned, and a great adhesive force between the layers.

Typically, to control reflectivity of material of layers, modified nanoparticles are added into a formulation system of the material. Therefore, reflectivity of the formulation system can be controlled by adjusting a concentration of the modified nanoparticles. However, after nanoparticles are modified, a lot of free-state ligands are generated. Reflectivity of a formulation system will be seriously affected if the modified particles are not purified. If the modified particles are purified by adding a precipitant, the modified particles will be accumulated and cannot be dispersed in the formulation system.

### SUMMARY

The present disclosure provides a purification method to purify a particle modified by a ligand without affecting dispersion effects of a purified particle.

To solve the above issues, technical solutions provided by the present disclosure are described as follows.

The present disclosure provides a method of purifying a particle, comprising a plurality of following steps:
preparing a purification solution, wherein the purification solution comprises a first purification solution and a second purification solution, and the first purification solution and the second purification solution are immiscible with each other;
completely mixing a mixed solution to be purified with the purification solution, and letting stand until a plurality of separated layers appear, wherein the mixed solution to be purified comprises a particle modified by a ligand, a free-state ligand, and a dispersant, a dispersion degree of the particle modified by the ligand in the first purification solution is greater than a dispersion degree of the particle modified by the ligand in the second purification solution, and a dispersion degree of the free-state ligand in the first purification solution is greater than a dispersion degree of the free-state ligand in the second purification solution;
removing a layer of liquid where the second purification solution is located, and extracting a layer of liquid where the first purification solution is located; and
freezing and drying the extracted layer of liquid to obtain a purified particle.

Optionally, in some embodiments, after the step of removing the layer of liquid where the second purification solution is located, and extracting the layer of liquid where the first purification solution is located, the method of purifying the particle comprises a plurality of following steps:
adding the second purification solution into the layer of liquid where the first purification solution is located, and letting completely mix with each other and stand until a plurality of separated layers appear, wherein a size of the layer of liquid where the first purification solution is located and a size of the added second purification solution are same; and
removing the layer of liquid where the second purification solution is located again, and extracting the layer of liquid where the first purification solution is located.

Optionally, in some embodiments, a ratio of a size of the mixed solution to a size of the purification solution ranges from 1:1 to 1:5.

Optionally, in some embodiments, a ratio of a size of the first purification solution to a size of the second purification solution ranges from 1:0.5 to 1:50.

Optionally, in some embodiments, a polarity of the first purification solution is greater than a polarity of the particle and a polarity of the dispersant, the polarity of the particle and the polarity of the dispersant are both greater than a polarity of the ligand, and the polarity of the ligand is greater than a polarity of the second purification solution.

Optionally, in some embodiments, a mutual solubility between the dispersant and the first purification solution is greater than a mutual solubility between the dispersant and the second purification solution.

Optionally, in some embodiments, the dispersant is an alcohol dispersant or a ketone dispersant, the ligand comprises one or more of mercaptan, fatty acid, and fatty amine, and the particle comprises one or more of a SiO₂ particle, a ZrO₂ particle, an organic microsphere particle, and a quantum-dot particle.

Optionally, in some embodiments, the first purification solution is water.

Optionally, in some embodiments, the second purification solution is alkane comprising 6 to 30 carbon atoms or olefin comprising 6 to 30 carbon atoms.

Optionally, in some embodiments, the second purification solution is n-hexane or cyclohexane.

The present disclosure provides a method of purifying a particle. An appropriate purification solution is prepared according to different polarities and solubilities of particles and free-state ligands. Free-state ligands are removed by a liquid separation method. Particles are purified to ensure a purification degree of the particles. Freezing and drying processes are performed to remove a liquid phase of separated layers, thereby obtaining dried particles. As such, physical and chemical properties of the particles are ensured, and dispersion effects of the particles in sequent processes are also ensured. Thus, an issue of particles unable to be dispersed due to deposition of the particles due to a precipitant directly added into a solution is prevented. The method of purifying the particles provided by the present disclosure ensures both the purification degree and the dispersion effect of the particles.

### DESCRIPTION OF DRAWINGS

Technical solutions and beneficial effects of the present disclosure are illustrated below in detail in conjunction with drawings and specific embodiments.

FIG. 1 is a flowchart showing a method of purifying a particle provided by an embodiment of the present disclosure.

FIG. 2 is a flowchart showing a method of purifying a particle provided by an embodiment of the present disclosure.

FIG. 3 is an infrared spectrum of an upper liquid layer provided by an embodiment of the present disclosure.

FIG. 4 is an infrared spectrum of a lower liquid layer provided by the embodiment of the present disclosure.

### DETAILED DESCRIPTION

Hereinafter preferred embodiments of the present disclosure will be described with reference to the accompanying drawings to exemplify the embodiments of the present disclosure can be implemented, which can fully describe the technical contents of the present disclosure to make the technical content of the present disclosure clearer and easy to understand. However, the described embodiments are only some of the embodiments of the present disclosure, but not all of the embodiments. All other embodiments obtained by those skilled in the art based on the embodiments of the present disclosure without creative efforts are within the scope of the present disclosure.

It should be understood that terms such as “upper,” “lower,” “front,” “rear,” “left,” “right,” “inside,” “outside,” “lateral” as well as derivative thereof should be construed to refer to the orientation as then described or as shown in the drawings under discussion. These relative terms are for convenience of description, do not require that the present disclosure be constructed or operated in a particular orientation, and shall not be construed as causing limitations to the present disclosure. These relative terms are for convenience of description, do not require that the present disclosure be constructed or operated in a particular orientation, and shall not be construed as causing limitations to the present disclosure.

The present disclosure provides a method of purifying a particle, which can solve an issue of conventional modified particles cannot both have a high purification degree and an improved dispersion effect.

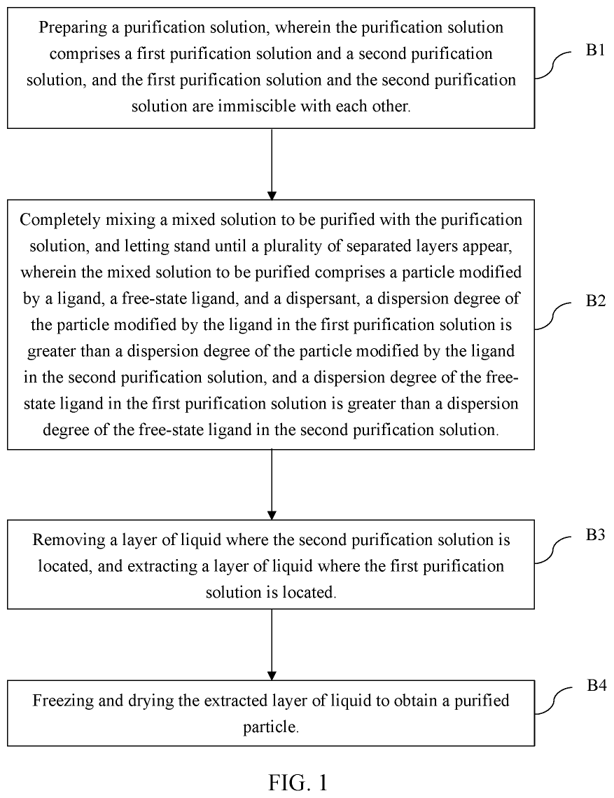

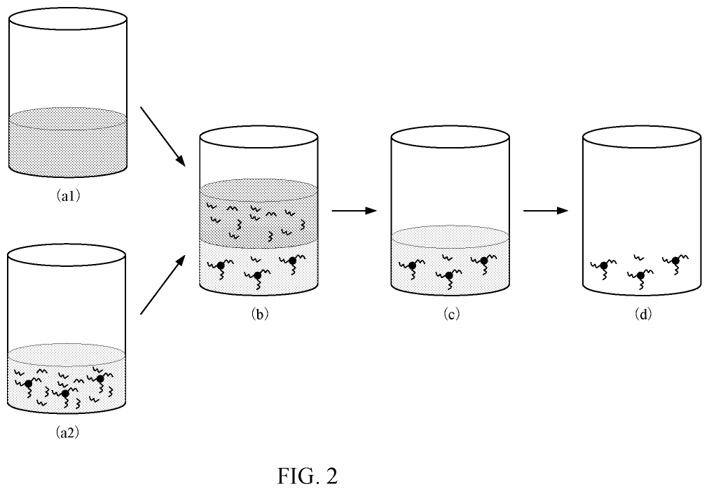

Please refer to FIG. 1 and FIG. 2. FIG. 1 is a flowchart showing a method of purifying a particle provided by an embodiment of the present disclosure. FIG. 2 is a flowchart showing a method of purifying a particle provided by an embodiment of the present disclosure. In one embodiment, the method of purifying the particle includes a plurality of following steps:
step B1, preparing a purification solution, wherein the purification solution comprises a first purification solution and a second purification solution, and the first purification solution and the second purification solution are immiscible with each other;
step B2, completely mixing a mixed solution to be purified with the purification solution, and letting stand until a plurality of separated layers appear, wherein the mixed solution to be purified comprises a particle modified by a ligand, a free-state ligand, and a dispersant, a dispersion degree of the particle modified by the ligand in the first purification solution is greater than a dispersion degree of the particle modified by the ligand in the second purification solution, a dispersion degree of the free-state ligand in the first purification solution is greater than a dispersion degree of the free-state ligand in the second purification solution;
step B3, removing a layer of liquid where the second purification solution is located, and extracting a layer of liquid where the first purification solution is located; and
step B4, freezing and drying the extracted layer of liquid to obtain a purified particle.

In the embodiment of the present disclosure, an appropriate purification solution is prepared according to different polarities and solubilities of particles and free-state ligands. Free-state ligands are removed by a liquid separation method. Particles are purified to ensure a purification degree of the particles. Freezing and drying processes are performed to remove a liquid phase of separated layers, thereby obtaining dried particles. As such, physical and chemical properties of the particles are ensured, and dispersion effects of the particles in sequent processes are also ensured. Thus, an issue of particles unable to be dispersed due to deposition of the particles due to a precipitant directly added into a solution is prevented. The method of purifying the particles provided by the present disclosure ensures both the purification degree and the dispersion effect of the particles.

In one embodiment, the particles are nanoscale particles. A size of the particles ranges from 2 nm to 10 μm. The particles include inorganic particle material and organic particle material. The inorganic particle material includes quantum-dot material such as CdSe quantum-dot material, InP quantum-dot material, ZnSe quantum-dot material, ZnCdS₂ quantum-dot material, and ZnS quantum-dot material. The inorganic particle material further includes a metal nanoparticle such as an Ag nanoparticle, an Au nanoparticle, and a Cu nanoparticle. The inorganic particle material may also be core shell material of the above material such as CdSe/ZnS and CdSe/SiO₂. The inorganic particle material further includes a plurality of nanoparticles having different shapes such as a mesopore particle, a hollow particle, a yolk structure particle, a nano line, a nano stave, and a nanosheet. The organic particle material includes, but is not limited to, an organic microsphere such as a miktoarm star-shaped styrene-methyl methacrylate copolymer.

The ligand has a weak polarity and a long-chain structure. An end of the ligand can be connected to the particles by a physical method or a chemical method. Another end of the ligand includes a group having weak polarity. The ligand includes a silane coupling agent such as KH-550 and KH-570. The ligand may further include a thiol ligand. Preferably, the ligand is alkyl mercapto including 4 to 14 carbon atoms such as dodecyl mercapto and decyl mercapto. The ligand further includes a fatty acid ligand. Preferably, the ligand is alkyl carboxylic acid including 8 to 16 carbon atoms and alkenyl carboxylic acid including 8 to 16 carbon atoms such as oleic acid, myristic acid, and octadecanoic acid. The ligand further includes a fatty amine ligand. Preferably, the ligand is enamine including 4 to 18 atoms and alkylamine including 4 to 18 atoms such as oleylamine, octadecylamine, butylamine, and trioctylamine. The ligand further includes an organophosphorus ligand such as tri-n-octylphosphine and tri-n-octylphosphine oxide.

The dispersant includes A relatively strong polarity and includes an organic reagent and an inorganic reagent which are liquid at room temperatures. The dispersant includes water. The dispersant further includes an alcohol dispersant such as methanol, ethanol, and isopropanol. The dispersant further includes a lipid dispersant such as ethyl acetate and butyl acetate. The dispersant further includes a hydrocarbon dispersant such as pentane, n-hexane, cyclohexane, heptane, octane, octadecene, and squalene. The dispersant further includes a ketone dispersant such as acetone, methyl ethyl ketone, and methyl isobutyl ketone.

The particles modified by the ligand are dispersed into the dispersant. Also, a great number of free-state ligands which do not modify the particles are dispersed into the dispersant. These free-state ligands are impurity particles which affect reflectivity of the particles. Therefore, these free-state ligands need to be purified. A mass concentration of the particles in a mixture solution ranges from 0.5% to 50%. Preferably, the mass concentration of the particles in the mixture solution ranges from 0.5% to 10%. A mass concentration of the ligand in the mixture solution ranges from 0.05% to 80%. Remaining components in the mixture solution include the dispersant.

In one specific embodiment, the particles are SiO₂ particles. The ligand is a silane coupling agent. The dispersant is ethanol. A method of purifying a particle provided by the embodiment of the present disclosure is described in detail below.

A surface of SiO₂ particles includes hydroxyl which has strong polarity. After the SiO₂ particles are modified by the silane coupling agent. A polarity of the SiO₂ particles is slightly reduced, but is still relatively strong. Therefore, the SiO₂ particles are easy to be dispersed into a solution having relatively strong polarity such as water and ethanol, and cannot be dispersed into a solution having relatively weak polarity such as n-hexane. A free-state silane coupling agent has weak polarity, and can be dispersed into water, ethanol, and n-hexane. However, a dispersion degree of the silane coupling agent in water and ethanol is less than a dispersion degree of the silane coupling agent in n-hexane.

A first purification solution is water. A second purification solution is n-hexane. The first purification solution and the second purification solution are mixed to obtain a purification solution, as shown in FIG. 2(al). A ratio of a size of water to a size of n-hexane ranges from 1:0.5 to 1:50. Preferably, the ratio of the size of water and the size of n-hexane ranges from 1:0.5 to 1:10. Polarity of water and polarity of n-hexane are very different. After a mixture of water and n-hexane is stood for a half minute, the mixture is separated into an upper layer and a lower layer. The upper layer is n-hexane having a relatively low density, and a lower layer is water having a relatively high density.

2 ml to 1 l of the mixture solution including ethanol, the SiO₂ particles, and the silane coupling agent (as shown in FIG. 2(a2)) and 2 ml to 1 l of purification solution including water and n-hexane are mixed, shaken or stirred, and stood for a while until separated layers appear (as shown in FIG. 2(b)). A ratio of a size of the mixture solution to a size of the purification solution ranges from 1:1 to 1:5. A stirring time ranges from 5 minutes to 30 minutes. A standing time ranges from 10 minutes to 60 minutes. A solution in the upper layer includes n-hexane having a relatively low density, and a solution in the lower layer includes water having a relatively high density. Because a dispersion degree of the silane coupling agent in n-hexane is greater than a dispersion degree of the silane coupling agent in water and ethanol, the solution in the upper layer includes a free-state silane coupling agent. Because a dispersion degree of ethanol in water is far greater than a dispersion degree of ethanol in n-hexane and a dispersion degree of the SiO₂ particles in water is far greater than a dispersion degree of the SiO₂ particles in n-hexane, the solution in the lower layer further includes the SiO₂ particles and ethanol. It should be noted that the size of the mixture solution and the size of the purification solution described here are only examples, and are not limitations. The mixture solution and the size of the purification solution can be enlarged in proportion.

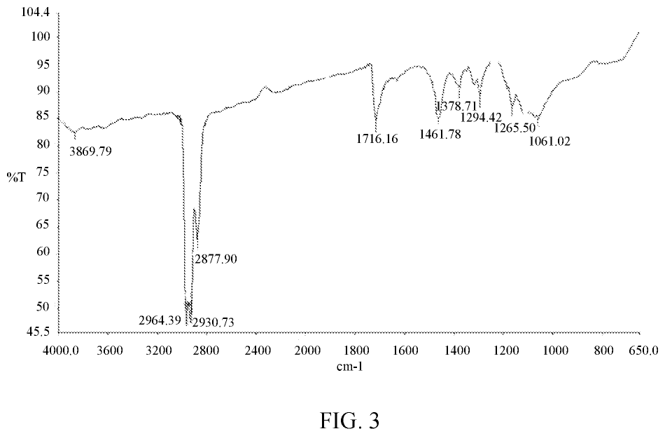

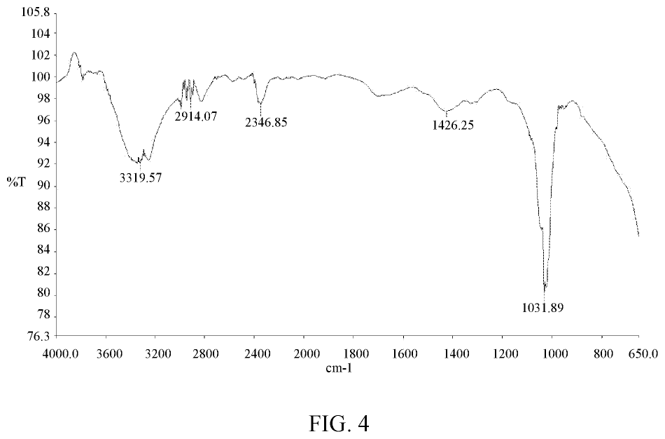

A n-hexane liquid in the upper layer is removed, and liquid in the lower layer is retained, as shown in FIG. 2(c). Please refer to FIG. 3 and FIG. 4. FIG. 3 is an infrared spectrum of an upper liquid layer provided by an embodiment of the present disclosure. FIG. 4 is an infrared spectrum of a lower liquid layer provided by the embodiment of the present disclosure. A lot of characteristic peaks of KH570 can be seen in FIG. 3, proving that a lot of functional groups of a silane coupling agent exist in the upper liquid layer, further proving that a lot of free-state silane coupling agents are removed by n-hexane. Only a few characteristic peaks of KH570 can be seen in FIG. 4, proving that free-state silane coupling agents in the lower liquid layer are removed.

The silane coupling agent can be dissolved in water and ethanol, a few free-state silane coupling agent still exists in the solution in the lower layer. After n-hexane liquid in the upper layer is removed, n-hexane having a same size of the removed n-hexane liquid can be further added into and mixed with a solution. After the solution is shaken or stirred, and is stood for a while, the solution will be separated into two layers. Then, n-hexane liquid in the upper layer is removed again, thereby obtaining purified liquid in the lower layer. By repeating the above steps 0 to 2 times, 80% free-state silane coupling agent can be removed.

Water and ethanol in the lower layer are removed by a freezing process and a drying process. Therefore, a powder the SiO₂ particles modified by the silane coupling agent and a small amount of free-state silane coupling agent can be obtained, as shown in FIG. 2(d).

In the method of purifying a particle provided by the embodiment of the present disclosure, by adjusting a ratio between the dispersant, the first purification solution, and the second purification solution and controlling adding times of the second purification solution, a cover rate of a ligand on a surface of purified particles and an amount of impurity ligands can be adjusted. As such, reflectivity, a curing rate, and hardness of ligand molecules can be controlled.

In summary, an embodiment of the present disclosure provides a method of purifying a particle. An appropriate purification solution is prepared according to different polarities and solubilities of particles and free-state ligands. Free-state ligands are removed by a liquid separation method. Particles are purified to ensure a purification degree of the particles. Freezing and drying processes are performed to remove a liquid phase of separated layers, thereby obtaining dried particles. As such, physical and chemical properties of the particles are ensured, and dispersion effects of the particles in sequent processes are also ensured. Thus, an issue of particles unable to be dispersed due to deposition of the particles due to a precipitant directly added into a solution is prevented. The method of purifying the particles provided by the present disclosure ensures both the purification degree and the dispersion effect of the particles.

The method of purifying a particle has been described in detail by embodiments of the present disclosure, which illustrates principles and implementations thereof. However, the description of the above embodiments is only for helping to understand the technical solution of the present disclosure and core ideas thereof, and it is understood by those skilled in the art that many changes and modifications to the described embodiment can be carried out without departing from the scope and the spirit of the disclosure that is intended to be limited only by the appended claims.

What is claimed is:

1. A method of purifying a particle, comprising a plurality of following steps:
preparing a purification solution, wherein the purification solution comprises a first purification solution and a second purification solution, and the first purification solution and the second purification solution are immiscible with each other;
fully mixing a mixed solution to be purified with the purification solution, and letting stand until a plurality of separated layers appear, wherein the mixed solution to be purified comprises a particle modified by a ligand, a free-state ligand, and a dispersant, a dispersion degree of the particle modified by the ligand in the first purification solution is greater than a dispersion degree of the particle modified by the ligand in the second purification solution, and a dispersion degree of the free-state ligand in the first purification solution is greater than a dispersion degree of the free-state ligand in the second purification solution;
removing a layer of liquid where the second purification solution is located, and extracting a layer of liquid where the first purification solution is located; and
freezing and drying the extracted layer of liquid to obtain a purified particle.

2. The method of claim 1, wherein after the step of removing the layer of liquid where the second purification solution is located, and extracting the layer of liquid where the first purification solution is located, the method of purifying the particle comprises a plurality of following steps:
adding the second purification solution into the layer of liquid where the first purification solution is located, and letting completely mix with each other and stand until a plurality of separated layers appear, wherein a size of the layer of liquid where the first purification solution is located and a size of the added second purification solution are same; and
removing the layer of liquid where the second purification solution is located again, and extracting the layer of liquid where the first purification solution is located.

3. The method of claim 1, wherein a ratio of a size of the mixed solution to a size of the purification solution ranges from 1:1 to 1:5.

4. The method of claim 3, wherein a ratio of a size of the first purification solution to a size of the second purification solution ranges from 1:0.5 to 1:50.

5. The method of claim 4, wherein a polarity of the first purification solution is greater than a polarity of the particle and a polarity of the dispersant, the polarity of the particle and the polarity of the dispersant are both greater than a polarity of the ligand, and the polarity of the ligand is greater than a polarity of the second purification solution.

6. The method of claim 5, wherein a mutual solubility between the dispersant and the first purification solution is greater than a mutual solubility between the dispersant and the second purification solution.

7. The method of claim 6, wherein the dispersant is an alcohol dispersant or a ketone dispersant, the ligand comprises one or more of mercaptan, fatty acid, and fatty amine, and the particle comprises one or more of a SiO₂ particle, a ZrO₂ particle, an organic microsphere particle, and a quantum-dot particle.

8. The method of claim 7, wherein the first purification solution is water.

9. The method of claim 8, wherein the second purification solution is alkane comprising 6 to 30 carbon atoms or olefin comprising 6 to 30 carbon atoms.

10. The method of claim 9, wherein the second purification solution is n-hexane or cyclohexane.
